(19) United States
(12) Patent Application Publication
(10) Pub. No.: US 2013/0153518 A1
(43) Pub. Date: Jun. 20, 2013

(54) SYSTEM AND METHOD FOR LIQUID-LIQUID SEPARATION

(71) Applicants: Steven Richardson, Thatcher, AZ (US); William Cashwell, Florence, SC (US); Jason M. Morgan, Morenci, AZ (US)

(72) Inventors: Steven Richardson, Thatcher, AZ (US); William Cashwell, Florence, SC (US); Jason M. Morgan, Morenci, AZ (US)

(73) Assignee: FREEPORT-MCMORAN CORPORATION, Phoenix, AZ (US)

(21) Appl. No.: 13/331,731

(22) Filed: Dec. 20, 2011

(51) Int. Cl. B01D 21/02; F16L 3/00; B01D 17/025

(52) U.S. Cl. 210/800; 210/519; 137/343

(57) ABSTRACT

The present invention provides a mixer-settler extraction circuit for separating liquids from each other. The mixer-settler extraction circuit includes a flow distributor. The flow distributor comprises a slat assembly which directs the incoming liquid into the settling portion of the mixer-settler extraction circuit. The slats of the slat assembly may be spaced apart from each other at varying distances.

### FIELD OF INVENTION

The invention relates to systems and methods for separating components of a mixture of liquids. In particular, this invention relates to systems and methods for controlling fluid flow in a liquid-liquid separation context. The systems include a mixer-settler, as well as a flow distributor.

### BACKGROUND OF THE INVENTION

Liquid-liquid separation systems are frequently utilized to separate mixtures of liquids. Extraction circuits, such as, for example, mixer-settlers, allow the liquid components of a mixture to separate by density. Typically, mixer-settlers include a mixing section, which mixes the incoming feed liquids to form a dispersion. The dispersion then progresses to a settling section, where the two liquid components settle and are selectively removed from the extraction circuit.

Mixer-settlers are commonly used in hydrometallurgical processes. For example, hydrometallurgical processes often utilize solvent extraction to remove metal values from pregnant leach solutions created by leaching processes. During solvent extraction, metal values from the pregnant leach solution are extracted into an organic extraction chemical. This extraction may be performed in a mixer-settler. In such configurations, the leach solution is forwarded to a mixer-settler, where the metal contained in the aqueous leach solution is extracted into the organic extraction chemical to create a loaded organic stream. The resulting loaded organic stream is forwarded to the mixer-settler. In the mixing section, a scrubbing solution is mixed with the organic phase. This dispersion is forwarded to the settling phase, which separates the organic solution from the metal value-containing aqueous solution.

In an exemplary hydrometallurgical process for extracting metal, such as, for example, copper, sulfide or oxide bearing minerals are leached to create a pregnant leach solution containing copper. The pregnant leach solution is forwarded to a solvent extraction system. A suitable organic extractant, such as, for example Alamine 336, aldoxime, an aldoxime/ketoxime blend, or a modified aldoxime/ketoxime blend, is used to extract the copper present in the pregnant leach solution, creating a loaded organic stream. The loaded organic is forwarded to a mixer-settler. In the mixing section, a stripping solution, such as an alkali metal base solution, is added to the loaded organic stream. The two liquids are mixed to create a dispersion. The dispersion is forwarded to the settling section of the circuit. The dispersion is separated into two liquid components in the settling section, and the stripped organic extractant and metal-containing stripping solution may be selectively removed from the circuit.

Conventional mixer-settlers utilize a flow distributor to control the fluid flow of the dispersion as it enters the settling section of the extraction circuit. For example, as the fluid enters the settling section of the circuit, it is beneficial to decrease the flow rate of the dispersion. It is also beneficial to create a linear flow front, so that the dispersion progresses through the settling at an even rate. A more linear flow front may reduce the entrainment of species present in the dispersion. Therefore, damming members, which may include traditional picket fences, may be used to beneficially modify the flow rate and profile of the dispersion.

### SUMMARY OF THE INVENTION

The present disclosure provides systems and methods for the separation of multiple liquid phases from a dispersion. Using the systems and methods of the present disclosure, a dispersion of two separable liquid components may be effectively separated. The present disclosure provides for improved forward progression of the dispersion through the mixer-settler circuit. As the dispersion moves across the flow distributor of the mixer-settler circuit, its velocity profile is improved to approach an even rate of forward progression, such as a plug flow model. Plug flow approximation helps to decrease entrainment, reduce separation times, and improve the separation efficiency of the mixer-settler circuit.

An exemplary flow distributor in accordance with the present disclosure comprises a support structure having a picket-fence configuration, a first slat assembly coupled to the support structure comprising a couplet of slats, a second slat assembly coupled to the support structure comprising a couplet of slats, a third slat assembly coupled to the support structure comprising a couplet of slats, wherein the slats of the second and third slat assemblies comprise beveled edge surfaces and may be variably spaced from one another. In various embodiments, the flow distributor has a substantially chevron-shaped configuration.

A mixer-settler assembly in accordance with the present disclosure comprises a vessel configured to conduct the flow of a liquid mixture and/or dispersion comprising an inbound portion, an outbound portion, a flow distributor having a chevron configuration, wherein the flow distributor has an apex configured to point in the direction of the inbound liquid mixture and/or dispersion.

A method in accordance with the present disclosure comprises introducing a liquid mixture and/or dispersion into an inbound portion of a vessel comprising the inbound portion and an outbound portion, and regulating the flow of the liquid mixture and/or dispersion by passing the it through a flow distributor having a chevron configuration, wherein the flow distributor has an apex configured to point in the direction of the inbound liquid mixture and/or dispersion.

### BRIEF DESCRIPTION OF THE DRAWINGS

The drawings described herein are for illustration purposes only and are not intended to limit the scope of the present disclosure in any way. The present disclosure will become more fully understood from the detailed description and the accompanying drawings herein:

FIG. 1 illustrates an exemplary hydrometallurgical metal recovery process;

FIG. 2 illustrates a top view of an exemplary mixer-settler apparatus;

FIG. 3 illustrates a top view of an exemplary flow distributor;

FIG. 4 illustrates a front view of an exemplary flow distributor;

FIG. 5 illustrates a top view of components of an exemplary flow distributor; and

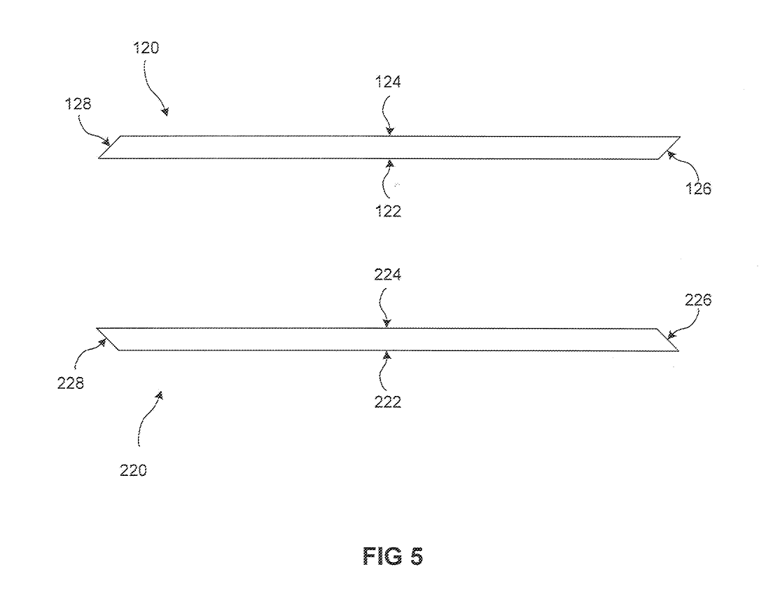

FIG. 6 illustrates a front view of an exemplary flow distributor.

### DETAILED DESCRIPTION

The detailed description of various embodiments herein makes reference to the accompanying drawing figures, which show various embodiments and implementations thereof by way of illustration and best mode, and not of limitation. While these embodiments are described in sufficient detail to enable those skilled in the art to practice the embodiments, it should be understood that other embodiments may be realized and that mechanical and other changes may be made without departing from the spirit and scope of the present disclosure. Furthermore, any reference to singular includes plural embodiments, and any reference to more than one component may include a singular embodiment.

Also, any reference to attached, fixed, connected or the like may include permanent, removable, temporary, partial, full and/or any other possible attachment option. Additionally, though the various embodiments discussed herein may be carried out in the context of metal recovery, it should be understood that systems and methods disclosed herein may be incorporated into anything needing to separate components of a dispersion in accordance with the present disclosure.

The various embodiments of a flow distributor comprise the features hereinafter described and particularly pointed out in the claims. The following description and the annexed drawings set forth in detail and demonstrate certain illustrative embodiments of the disclosure. However, these embodiments are indicative of but a few of the various ways in which the principles disclosed herein may be employed. Other objects, advantages and novel features will become apparent from the following detailed description when considered in conjunction with the drawings.

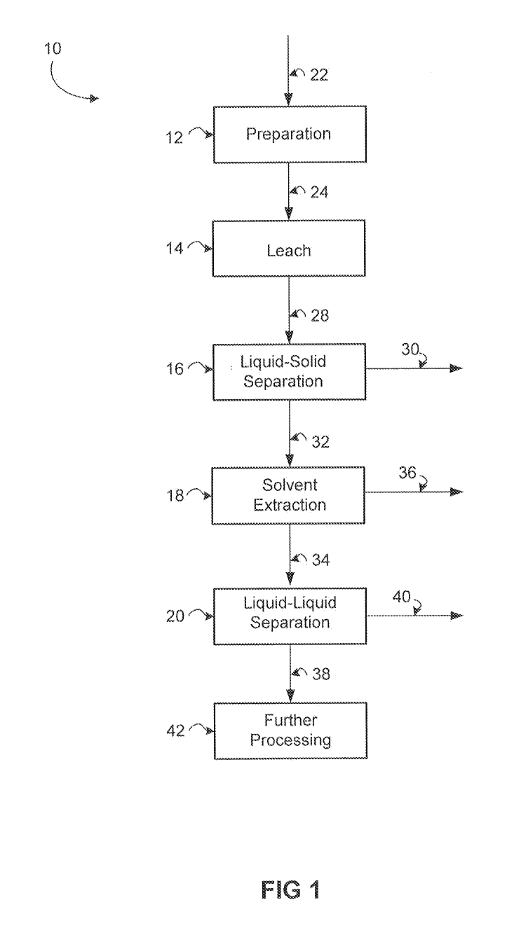

To assist in understanding the context of the present disclosure, an exemplary hydrometallurgical metal recovery process configured to utilize systems and methods to separate dispersions in accordance with the present disclosure is illustrated in FIG. 1. In the exemplary process, metal bearing material 22 is subjected to hydrometallurgical metal recovery process 10 to recover metal value contained in the sulfide ore. Metal bearing mineral 22 may include chalcopyrite (CuFeS₂), chalcocite (Cu₂S), bornite (Cu₅FeS₄), and covellite (CuS), malachite (Cu₂CO₃(OH)₂), pseudomalachite (Cu₅[(OH)₂PO₄]₂), azurite (Cu₃(CO₃)₂(OH)₂), chrysocolla ((Cu,Al)₂H₂Si₂O₅(OH)₄.nH₂O), cuprite (Cu₂O), brochanite (CuSO₄.3Cu(OH)₂), atacamite (Cu₂[OH₃Cl]) and other copper-bearing minerals. Metal bearing material 22 may comprise any metal suitable for extraction via solvent extraction.

Metal bearing material 22 is processed in a preparation step 12, creating prepared metal bearing material 24. Prepared metal bearing material 24 is forwarded to a leach step 14. Leach step 14 produces a metal bearing slurry 28, which is forwarded to a solid-liquid separation step 16. Leach step 14 may comprise a pressure leach, heap leach, and/or agitation process. Solid-liquid step 16 produces a solid residue 30 and a metal bearing solution 32. Metal bearing solution 32 is then subjected to a solvent extraction step 18. Solvent extraction step 18 produces a loaded organic stream 34 and an extracted solution 36. Loaded organic stream 34 is processed by a liquid-liquid separation step 20, which produces a barren organic stream 40 and a separated metal bearing solution 38. In various embodiments, separated metal bearing solution 38 comprises a rich electrolyte. Separated metal bearing solution 38 may then be subjected to a further processing step 42, such as, for example, electrowinning.

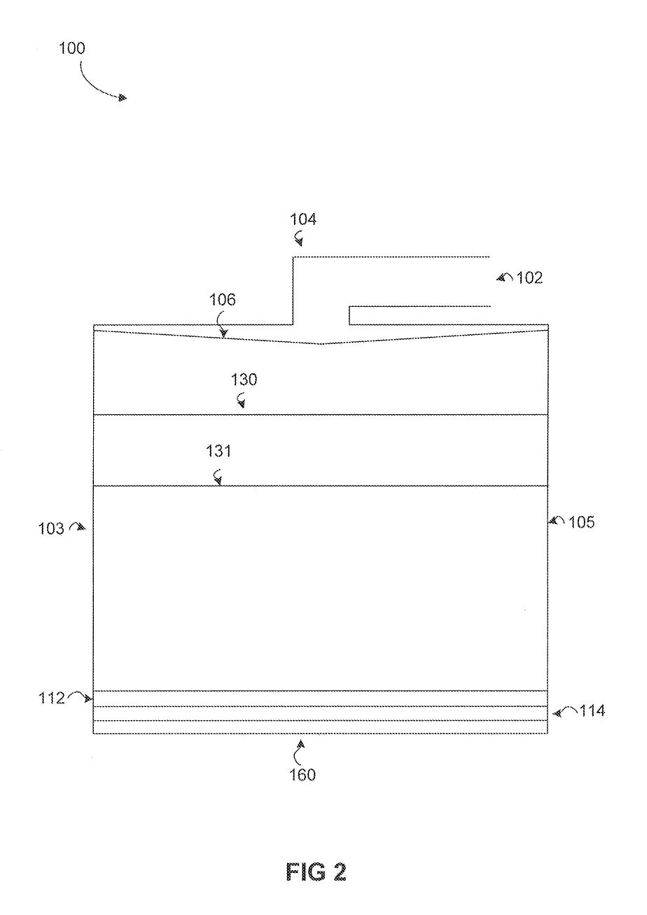

In accordance with various embodiments, liquid-liquid separation step 20 comprises a mixer-settler extraction circuit. With initial reference to FIG. 2, an exemplary settling section 100 is illustrated. A feed 102 enters settling section 100 at a feed section 104. In an exemplary embodiment, feed 102 comprises loaded organic stream 34 from hydrometallurgical metal recovery process 10. However, feed 102 may be any mixture containing at least two immiscible and separable liquids, including a dispersion and/or emulsion.

In various exemplary embodiments, settling section 100 further comprises a perimeter wall 103 and a perimeter wall 105. Further, settling section 100 may comprise a discharge section 160. In various exemplary embodiments, separated liquid phases exit the settling section 100 from discharge section 160.

In accordance with an exemplary embodiment, and with continued reference to FIG. 2, settling section 100 further comprises a primary flow distributor 106. Settling section 100 may further comprise a secondary flow distributor 130 and a tertiary flow distributor 131. Although FIG. 2 illustrates two additional flow distributors, the use of any number of additional flow distributors is in accordance with the present disclosure.

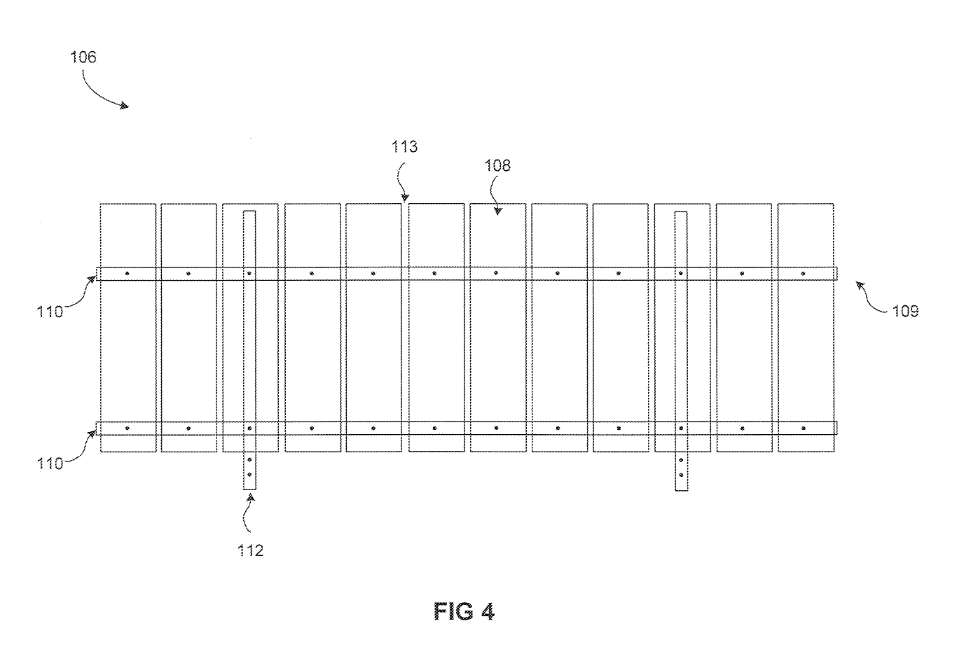

With reference to FIG. 4, primary flow distributor 106 may comprise a support structure 109. In various exemplary embodiments, support structure 109 comprises at least one horizontal support member 110. In a preferred embodiment, support structure 109 comprises two horizontal support members 110. In various exemplary embodiments, support structure 109 may further comprise at least one vertical support member 112. In a preferred embodiment, the support structure comprises a plurality of vertical support members 112 connected to horizontal support members 110. Other exemplary support structure 109 configurations may include a series of cross braces, floor mounted brackets, and/or top caps. However, any configuration of support structure 109 that provides adequate support for primary flow distributor 106 is in accordance with the present disclosure.

In various exemplary embodiments, support structure 109 comprises a corrosion resistant material. The material selected for support structure 109 may be dependent on the compositions of feed 102. For example, support structure 109 may comprise ABS, nylon, PTFE, polyvinyl chloride, fiberglass reinforced plastic, or any suitable corrosion resistant plastic material. Support structure 109 may also comprise stainless steel, aluminum, titanium, or any suitable corrosion resistant metal. Any material which provides sufficient structural rigidity and durability to support structure 109 and is suitable for use with the components of feed 102 is in accordance with the present invention.

In various exemplary embodiments, primary flow distributor 106 comprises a plurality of slats 108. In various exemplary embodiments, slats 108 are connected to the components of support structure 109. In a preferred embodiment, slats 108 are connected to at least one horizontal support member 110. Slats 108 may be connected to at least one horizontal support member 110 by bolts, clips, or any other suitable fastener. In addition, slats 108 may be connected to horizontal support member 110 by permanent means, such as welding. However, any method of attachment which joins slats 108 to support structure 109 and/or horizontal members 110 is in accordance with the present disclosure.

In various exemplary embodiments, support structure 109 is configured to orient slats 108 in a substantially linear configuration. In other exemplary embodiments, support structure 109 is configured to hold slats 108 in a substantially chevron-shaped configuration. In yet other embodiments, support structure 109 is configured to hold slats 108 in a substantially configuration. In a preferred embodiment, support structure 109 orients slats 108 in a chevron-shaped configuration, the apex of which faces in the direction of the flow of feed 102.

In various exemplary embodiments, slats 108 comprise a corrosion resistant material. The material selected for slats 108 may be dependent on the composition of feed 102. For example, slats 108 may comprise ABS, nylon, PTFE, or any suitable corrosion resistant plastic material. Slats 108 may also comprise stainless steel, aluminum, titanium, or any suitable corrosion resistant metal. Any material which is suitable for use with the components of feed 102 is in accordance with the present invention.

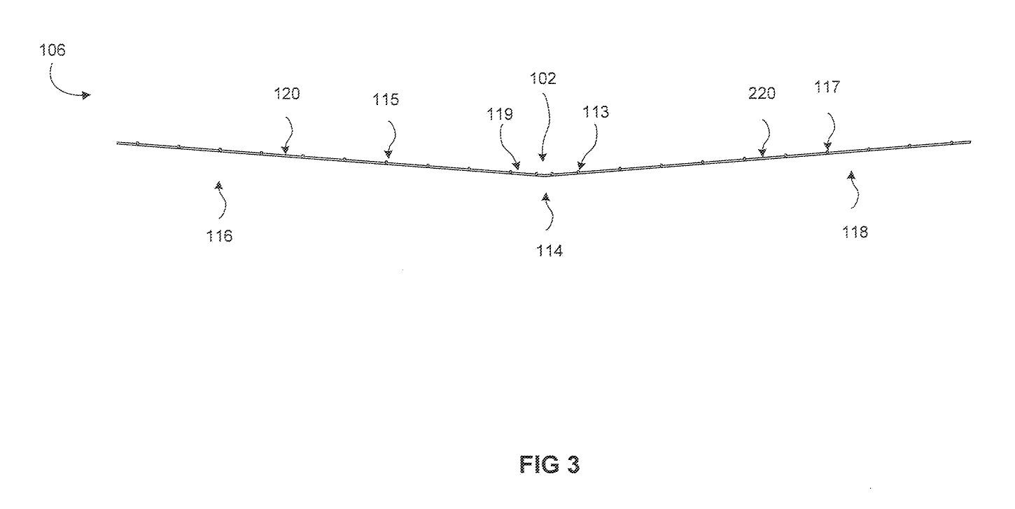

In various exemplary embodiments, primary flow distributor 106 may comprise a number of different types of slats 108. For example, primary flow distributor 106 may comprise slats 108 of three different configurations. With reference to FIG. 3, in an exemplary embodiment, flow distributor 106 comprises a first section 114, a second section 116, and a third section 118. Each section (114, 116, and 118) may be comprised of slats 108 that differ from each other in size and shape. For example, primary flow distributor 106 may comprise slats 108 of varying widths and/or heights.

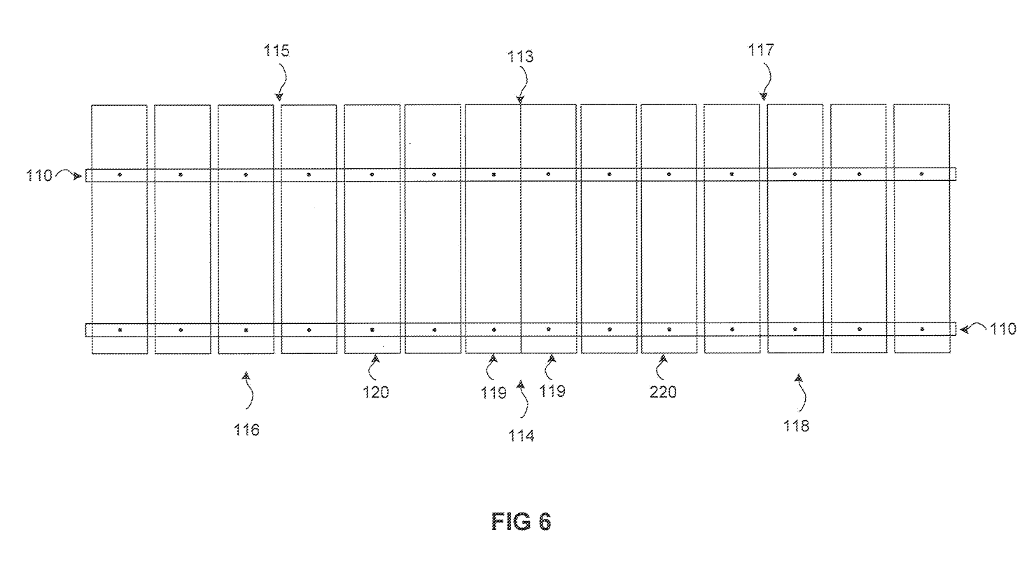

With reference to FIGS. 3 and 6, in various exemplary embodiments, first section 114 comprises at least a pair of first section slats 119. In an exemplary embodiment, first section 114 is situated in the center of flow distributor 106. In another exemplary embodiment, first section 114 is situated at the apex of the flow distributor 106, so that first section 114 comprises the peak of the chevron-shaped configuration. In a preferred embodiment, first section 114 is symmetrical about a plane bisecting the apex of flow distributor 106.

In a preferred embodiment, first section slats 119 comprise a substantially rectangular configuration, including a parallel front face and rear face of substantially the same height and width. First section slats 119 further comprise a left side face and right side face of substantially the same height and width. In various exemplary embodiments, first section slats 119 are separated by gaps 113. In a preferred embodiment, each first section slat 119 is spaced equidistantly from each other, so that each gap 113 is the same dimension. However, any spacing of first section slats 119 that provides sufficient flow distribution, including variable dimensions of gaps 113, is in accordance with the present disclosure.

With reference to FIGS. 3 and 6, in an exemplary embodiment, second section 116 comprises at least a pair of second section slats 120. In an exemplary embodiment, second section 116 is adjacent to first section 114. Preferably, second section 116 is positioned between first section 114 and perimeter wall 103 of settling section 100.

With reference to various figures, including FIGS. 3 and 6, in various exemplary embodiments, second section slats 120 are separated by gaps 115. Gaps 115 may comprise various differing dimensions. In a preferred embodiment, gaps 115 may increase in dimension from the second section slat 120 closest to first section 114 to the second section slat 120 closest to the wall of mixer-settler 100. However, any spacing of second section slats 120 that provides sufficient flow distribution is in accordance with the present disclosure.

With reference to FIG. 6, in a preferred embodiment, second section slats 120 comprise a substantially parallelogram configuration. Second section slats 120 comprise a front face 122 and a substantially parallel rear face 124. Front face 122 and rear face 124 are substantially the same height and width as each other. Second section slats 120 further comprise a beveled left side face 128 and a substantially parallel right side face 126. Left side face 128 and right side face 126 are substantially the same height and width as each other. In a preferred embodiment, left side face 128 and right side face 126 are beveled to an angle 45 degrees below the plane of front face 122. Left side face 128 and right side face 126 are configured to reduce the sideways velocity of feed 102 and direct the flow towards discharge section 160. However, any dimensions of the various components of second section slats 120 (122, 124, 126 and 128), as well as any degree of bevel, which facilitates reducing the sideways velocity of feed 102 is in accordance with the present disclosure.

With reference to FIGS. 3 and 6, in an exemplary embodiment, third section 118 comprises at least a pair of third section slats 220. In an exemplary embodiment, third section 118 is adjacent to first section 114. Preferably, third section 118 is positioned between first section 114 and perimeter wall 105 of settling section 100. In a preferred embodiment, second section 116 and third section 118 are symmetrical about a plane which bisects the apex of flow distributor 106.

With reference to various figures, including FIGS. 3 and 6, in various exemplary embodiments, third section slats 220 are separated by gaps 117. Gaps 117 may comprise various differing dimensions. In a preferred embodiment, gaps 117 may increase in dimension from the third section slat 220 closest to first section 114 to the third section slat 220 closest to perimeter wall 105 of settling section 100. However, any spacing of third section slats 220 that provides sufficient flow distribution is in accordance with the present disclosure.

With reference to FIG. 6, in a preferred embodiment, third section slats 220 comprise a substantially parallelogram configuration. Third section slats 220 comprise a front face 222 and a substantially parallel rear face 224. Front face 222 and rear face 224 are substantially the same height and width as each other. Third section slats 220 further comprise a beveled left side face 228 and a substantially parallel right side face 226. Left side face 228 and right side face 226 are substantially the same height and width as each other. In a preferred embodiment, left side face 228 and right side face 226 are beveled to an angle 45 degrees above the plane of front face 222. Left side face 228 and right side face 226 are configured to reduce the sideways velocity of feed 102 and direct the flow towards discharge section 160. However, any dimensions of the various components of second section slats 220 (222, 224, 226 and 228), as well as any degree of bevel, which facilitates reducing the sideways velocity of feed 102 is in accordance with the present disclosure.

In accordance with various exemplary embodiments, first section slats 119, second section slats 120, and third section slats 220 comprise varying widths. For example, first section slats 119 may vary in width across first section 114. Second section slats 120 may vary in width across second section 116, and third section slats 220 may vary in width across third section 118. Any configuration of first section slats 119, second section slats 120 and third section slats 220 which facilitates reducing the sideways velocity of feed 102, including the use of slats of varying width, is in accordance with the present disclosure.

In accordance with various exemplary embodiments, settling section 100 further comprises a primary phase weir 112 and a secondary phase weir 114. In various embodiments, primary phase weir 112 and secondary phase weir 114 are located in a discharge section 160.

In various exemplary embodiments, as feed 102 progresses through settling section 100, feed 102 is separated into two phases; a primary phase 121 and a secondary phase 123. Each of the two phases is isolated in a corresponding weir. In various exemplary embodiments, primary phase 121 is an organic phase. In various exemplary embodiments, secondary phase 123 is an aqueous phase which contains the metal values to be recovered in hydrometallurgical metal recovery process 10. However, primary phase 121 (not shown) and secondary phase 123 (not shown) may be any liquids which are inclined to separate from each other in settling section 100 in accordance with the present disclosure.

In an exemplary embodiment, primary phase weir 112 isolates primary phase 121 of feed 102. Primary weir 112 may comprise a well, adjustable weir, outlet pipe or pipes, extraction chute and/or collection channel. However, any physical structure which allows for the selective separation and removal of primary phase 121 from feed 102 is in accordance with the present disclosure.

In an exemplary embodiment, secondary phase weir 114 isolates secondary phase 123 of feed 102. Secondary weir 114 may comprise a well, adjustable weir, outlet pipe or pipes, extraction chute and/or collection channel. However, any physical structure which allows for the selective separation and removal of secondary phase 123 from feed 102 is in accordance with the present disclosure.

Thus, the flow distributor of the present disclosure provides means to control the fluid flow of a dispersion as it progresses through an extraction circuit. The flow distributor beneficially decreases the flow rate of the dispersion and creates an approximately linear flow front, which allows the dispersion to progress through the circuit at a more even rate.

Finally, the present disclosure has been described above with reference to a number of exemplary embodiments. It should be appreciated that the particular embodiments shown and described herein are illustrative of the invention and its best mode and are not intended to limit in any way the scope of the invention. Those skilled in the art having read this disclosure will recognize that changes and modifications may be made to the exemplary embodiments without departing from the scope of the present invention. Various aspects and embodiments of this invention may be applied to fields of use other than copper mining. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

1. A primary flow distributor comprising:
a support structure;
a first slat assembly coupled to the support structure and comprising a first and second slat;
a second slat assembly coupled to the support structure and comprising a first and second slat;
a third slat assembly coupled to the support structure and comprising a first and second slat;
wherein the first slat of the first slat assembly has a beveled edge surface and the second slat of the first slat assembly has a beveled edge surface configured to be substantially parallel to the beveled edge surface of the first slat of the first slat assembly; and
wherein the first slat of the second slat assembly has a beveled edge surface and the second slat of the second slat assembly has a beveled edge surface configured to be substantially parallel to the beveled edge surface of the first slat of the second slat assembly.

2. The flow distributor of claim 1, wherein the beveled edge surface of the first slat of the first slat assembly lies in an intersecting plane with the beveled edge surface of the first slat of the second slat assembly.

3. The flow distributor of claim 1, wherein the first slat of the third slat assembly has a square edge surface and the second slat of the third slat assembly has a square edge surface.

4. The flow distributor of claim 3, wherein the square edge surface of the first slat of the third slat assembly is in contact with the square edge surface and the second slat of the third slat assembly.

5. The flow distributor of claim 3, wherein the first slat of the third slat assembly is wider than the first slat of the first slat assembly.

6. The flow distributor of claim 1, wherein the first slat assembly further comprises a third slat; wherein the distance between the first slat and second slat is different from the distance between the second slat and third slat.

7. The flow distributor of claim 1, wherein the second slat assembly further comprises a third slat; wherein the distance between the first slat and second slat is different from the distance between the second slat and third slat.

8. The flow distributor of claim 1, wherein the support structure comprises a substantially chevron-shaped configuration.

9. The flow distributor of claim 1, wherein the support structure comprises a substantially linear configuration.

10. The flow distributor of claim 1, wherein the support structure comprises a corrosion resistant material.

11. A mixer-settler assembly comprising:
a vessel configured to conduct the flow of a liquid comprising an inbound portion and an outbound portion;
a flow distributor comprising:
a support structure;
a first slat assembly coupled to the support structure and comprising a first and second slat;
a second slat assembly coupled to the support structure and comprising a first and second slat;
a third slat assembly coupled to the support structure and comprising a first and second slat;
wherein the first slat of the first slat assembly has a beveled edge surface and the second slat of the first slat assembly has a beveled edge surface configured to be substantially parallel to the beveled edge surface of the first slat of the first slat assembly; and
wherein the first slat of the second slat assembly has a beveled edge surface and the second slat of the second slat assembly has a beveled edge surface configured to be substantially parallel to the beveled edge surface of the first slat of the second slat assembly.

12. The mixer-settler assembly of claim 11, wherein the beveled edge surface of the first slat of the first slat assembly lies in an intersecting plane with the beveled edge surface of the first slat of the second slat assembly.

13. The mixer-settler assembly of claim 11, wherein the first slat of the third slat assembly has a square edge surface and the second slat of the third slat assembly has a square edge surface.

14. The mixer-settler assembly of claim 13, wherein the square edge surface of the first slat of the third slat assembly is in contact with the square edge surface and the second slat of the third slat assembly.

15. The mixer-settler assembly of claim 11, wherein the first slat of the third slat assembly is wider than the first slat of the first picket fence assembly.

16. The mixer-settler assembly of claim 11, wherein the first slat assembly further comprises a third slat; wherein the distance between the first slat and second slat is different from the distance between the second slat and third slat.

17. The mixer-settler assembly of claim 11, wherein the second slat assembly further comprises a third slat; wherein the distance between the first slat and second slat is different from the distance between the second slat and third slat.

18. The mixer-settler assembly of claim 11, wherein the support structure comprises a corrosion resistant material.

19. The mixer-settler assembly of claim 11, wherein the support structure comprises a substantially chevron-shaped configuration and the apex or the chevron faces toward the outbound portion of the vessel.

20. The mixer-settler assembly of claim 11, wherein the support structure comprises a substantially linear configuration.

21. A method comprising:
introducing a liquid into an inbound portion of a vessel comprising the inbound portion and an outbound portion; and
regulating the flow of the liquid by passing the liquid through a flow distributor comprising:
a support structure;
a first slat assembly coupled to the support structure and comprising a first and second slat;
a second slat assembly coupled to the support structure and comprising a first and second slat;
a third slat assembly coupled to the support structure and comprising a first and second slat;
wherein the first slat of the first slat assembly has a beveled edge surface and the second slat of the first slat assembly has a beveled edge surface configured to be substantially parallel to the beveled edge surface of the first slat of the first slat assembly; and
wherein the first slat of the second slat assembly has a beveled edge surface and the second slat of the second slat assembly has a beveled edge surface configured to be substantially parallel to the beveled edge surface or the first slat of the second slat assembly.

22. The method of claim 21, wherein the first slat assembly comprises a third slat; wherein the distance between the first slat and second slat is different from the distance between the second slat and third slat.

23. The method of claim 21, wherein the second slat assembly further comprises a third slat; wherein the distance between the first slat and second slat is different from the distance between the second slat and third slat.

24. The method of claim 21, wherein the liquid is a liquid used in a liquid-liquid extraction process.

25. The method of claim 21, wherein the liquid comprises a metal value.

26. The method of claim 21, wherein the liquid comprises at least one of an aqueous and an organic phase.

27. The mixer-settler assembly of claim 21, wherein the support structure comprises a substantially chevron-shaped configuration and the apex of the chevron faces toward the outbound portion of the vessel.

28. The mixer-settler assembly of claim 21, wherein the support structure comprises a substantially linear configuration.
